(19) United States
(12) Patent Application Publication
(10) Pub. No.: US 2025/0125472 A1
(43) Pub. Date: Apr. 17, 2025

(54) INTEGRATED FINGER PROOF HIGH VOLTAGE INTERFACE SOLUTION FOR BATTERY ASSEMBLY

(71) Applicant: Ford Global Technologies, LLC, Dearborn, MI (US)

(72) Inventors: Francisco Fernandez-Galindo, Canton, MI (US); Michael Barr, Canton, MI (US); Daniel Roberts, Livonia, MI (US); Rajaram Subramanian, Ann Arbor, MI (US)

(21) Appl. No.: 18/488,889

(22) Filed: Oct. 17, 2023

(51) Int. Cl. H01M 50/264; H01M 50/505

(52) U.S. Cl. CPC H01M 50/264; H01M 50/505; H01M 2220/20

(57) ABSTRACT

A battery pack, comprising: a first battery array; a second battery array; and an electrical joint assembly having an electrical joint and a plurality of non-conductive fasteners, the second battery array coupled to the first battery array via the electrical joint assembly with the plurality of non-conductive fasteners.

### TECHNICAL FIELD

The field relates to fasteners for use in an electrical assembly for a battery of a vehicle.

### BACKGROUND AND SUMMARY

Vehicles, such as electrified vehicles, may have a bus bar as an electrical joint for electrically coupling electrical components. The bus bar may be rated for and have high voltages between the electrical components electrically coupled via the bus bar. The electrical components may be part of a larger system, such as a battery pack. There may be a plurality of fasteners to fasten the bus bar to one of or a plurality of the electrical components.

Components of the electrical assembly, such as a cover, may be installed and physically coupled via clamping. Clamping may be performed via components of an operator or components, such as tools, manipulated by components of an operator. To reduce electrical discharge between the bus bar and an object, the cover may reduce the potential for objects, such as cylindrically shaped objects above a threshold diameter, from touching the bus bar or other electrified components of the electrical assembly.

Due to the increased use of packing space by the electrified components, the volume and height of the electrical assembly may be limited. This constraint may limit the ability of the cover to effectively reduce potential electric discharge to an object. Likewise, the cover for the assembly may have regions, referred to herein as fastener interface regions, where each fastener interface region may have openings about the helical axis through which a fastener may be accessed or installed. While reducing the size of the interface region openings may reduce the potential for electrical discharge to objects, it also may increase the difficultly of manufacturing and/or maintenance, such as the installation or removal of the fastener.

The inventors herein have recognized these and other issues with such systems and have come up with a way to at least partially solve them. In an example, a battery pack is provided. The battery pack may comprise: a first battery array; a second battery array; and an electrical joint assembly comprising an electrical joint and a plurality of non-conductive fasteners, the second battery array coupled to the first battery array via the electrical joint assembly with the non-conductive fasteners.

In another example, a battery pack is provided, comprising: a first battery array; a second a battery array coupled to the first battery array by a bus bar assembly, the bus bar assembly couple to the first array and the second array by non-conductive fasteners.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example schematic of a vehicle which may include the transmission of the present disclosure.

FIG. 2 shows an example schematic of a bus bar assembly with a bus bar electrically coupling a first array terminal and a second array terminal.

FIG. 3 shows the bus bar fastened to the first array terminal of FIG. 2 with a first configuration of fastener.

FIG. 4 shows the bus bar fastened to the first array terminal of FIG. 2 with a second configuration of fastener.

FIG. 5 shows the bus bar fastened to the first array terminal of FIG. 2 with a third configuration of fastener.

FIG. 6 shows a first view of a bus bar assembly with a bus bar cover and a configuration of fasteners of the present disclosure.

### DETAILED DESCRIPTION

The following description relates to the configurations of a fastener that may be referred to herein as mating fastener, of a bus bar, or of a high voltage joint. The mating fastener and/or a plurality of mating fasteners may fasten and place the bus bar in surface sharing contact with electrical components or components that may be charged by or conduct electricity, such as a one or a plurality of array terminals. An electrical assembly may comprise the bus bar, the mating fasteners, a cover, and electrical components, wherein the bus bar may be fastened to the electrical components. If a bus bar is used as the high voltage joint, the assembly may also be referred to herein as a bus bar assembly. The electrical assembly may electrically couple at least two array terminals via the high voltage electrical joint. The assembly may be part of a battery pack. The assembly may electrically couple a first array and a second array, wherein the first array and second array may be battery arrays part of, joined to, or physical coupled to other components of the battery pack. The high voltage electrical joint may be electrically coupled to an electrical component when in surface sharing contact with the electrical component. The mating fasteners may be non-conducting so as to prevent or insulate and dampen the transfer of electrical discharge from the bus bar to the fasteners. The mating fasteners may therein be non-conductive fasteners.

The non-conductive properties of the fasteners may allow for the fasteners to be in surface sharing contact with an external object, such as an object that may be conducting and grounded, without discharging electrical energy. Therefore, a cover for a high voltage electrical joint may not have to prevent an external object coming into surface sharing contact with the fastener in order to reduce the potential for discharge to that object. For example, as non-conductive fasteners, the mating fasteners may reduce discharge of electricity from the bus bar to an external object, such as a cylindrically shaped object, that may be in intermittent surface sharing contact with one of the fasteners via the fastener interface region. The mating fasteners may be used with or without a bus bar cover.

As described herein, to reduce packaging space, a fastener interface region including the z-space or height above the fastener may be shortened for a hole, flange, and/or other features of a bus bar cover about the fasteners. However, the shortened height of the fastener interface region and/or other components of the bus bar cover may allow for surface sharing contact between external objects and the fasteners. The fastener as described herein may reduce this surface sharing contact between the object and the high voltage electrical joint. The mating fasteners may also provide interference for external objects before coming into surface sharing contact with the bus bar or other electrical joint, such as when clamping the joint during manufacturing or maintenance, thereby reducing discharge into the foreign object during clamping components near or a part of the electrical assembly.

For one example, the mating fasteners may be made with a material comprising a dielectric material, such that the mating fasteners do not substantially electrically couple to the bus bar when fastened to the bus bar. In other examples, the mating fasteners may be coated with dielectric material or have components comprising dielectric material, such that components of the mating fasteners comprised of dielectric material do not electrically couple to the bus bar when the mating fasteners are fastened to the bus bar. Dielectric coatings for the mating fasteners may include anodized material.

A plurality of washers may be complementary to and used in conjunction with each of the fasteners to fasten the bus bar or other electrical joint. Each of the washers may comprise or be coated with dielectric material. The washers may spread the load and pressure uniformly across a surface of a component the bus bar or electrical joint is fastened to. The mating fasteners may be heat resistant and made with stable materials that can be fastened to achieve desired clamp loads. The dielectric material that comprises the mating fasteners, a coated layer of the mating fasteners, and/or components of the mating fasteners may be heat resistant and a stable material that may be resistant to degradation from mechanical forces and chemical corrosion.

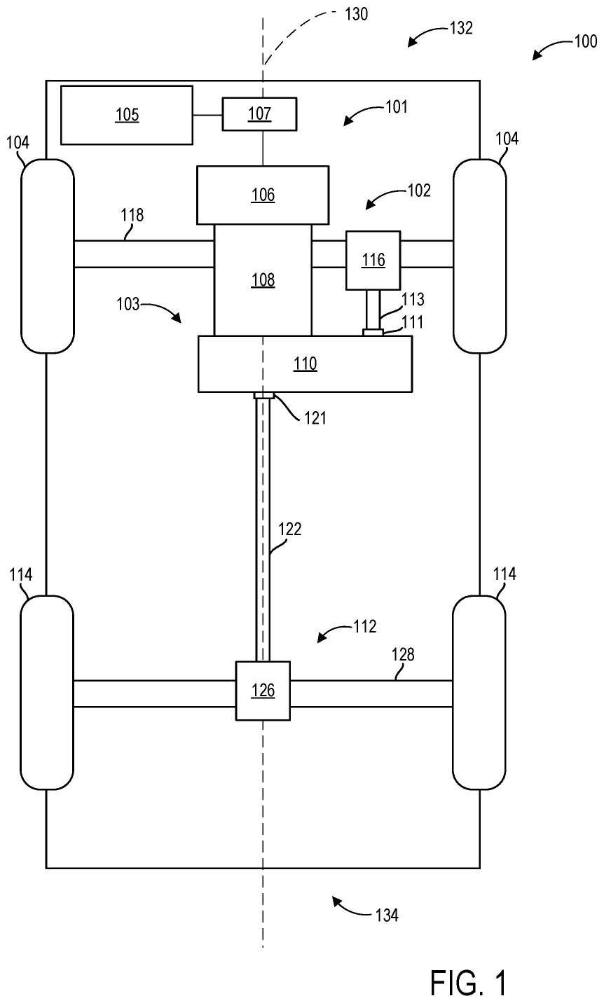

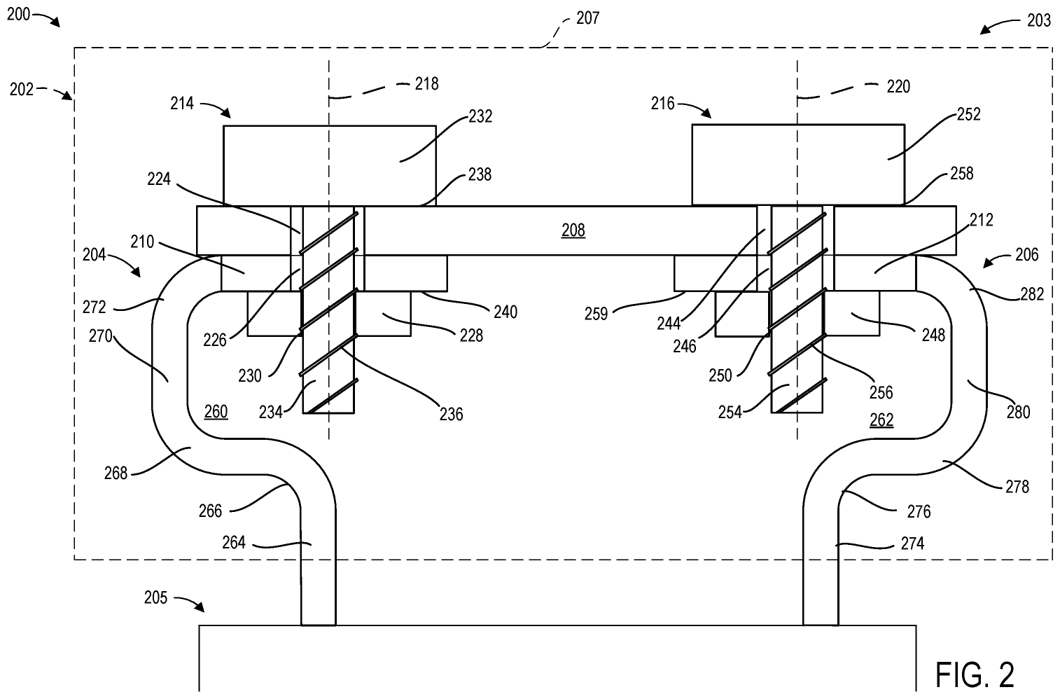

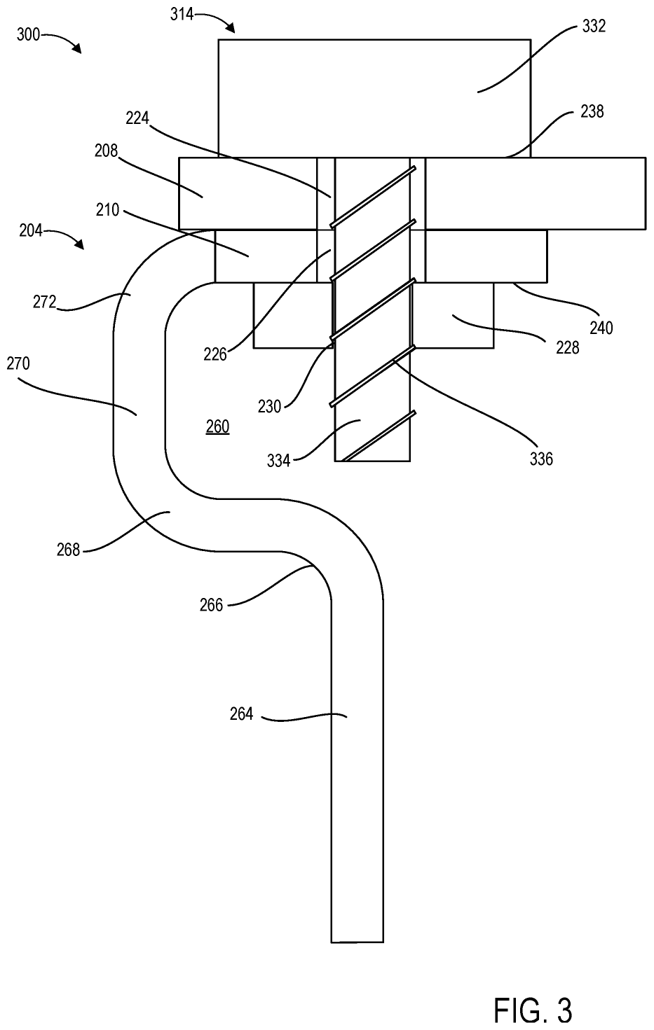

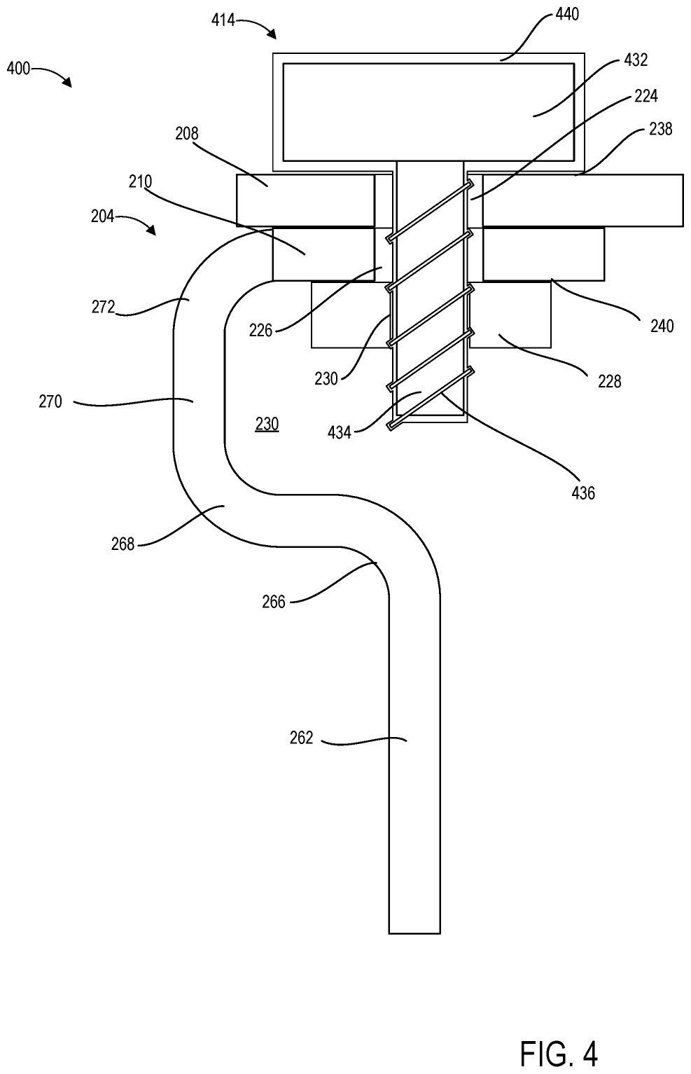

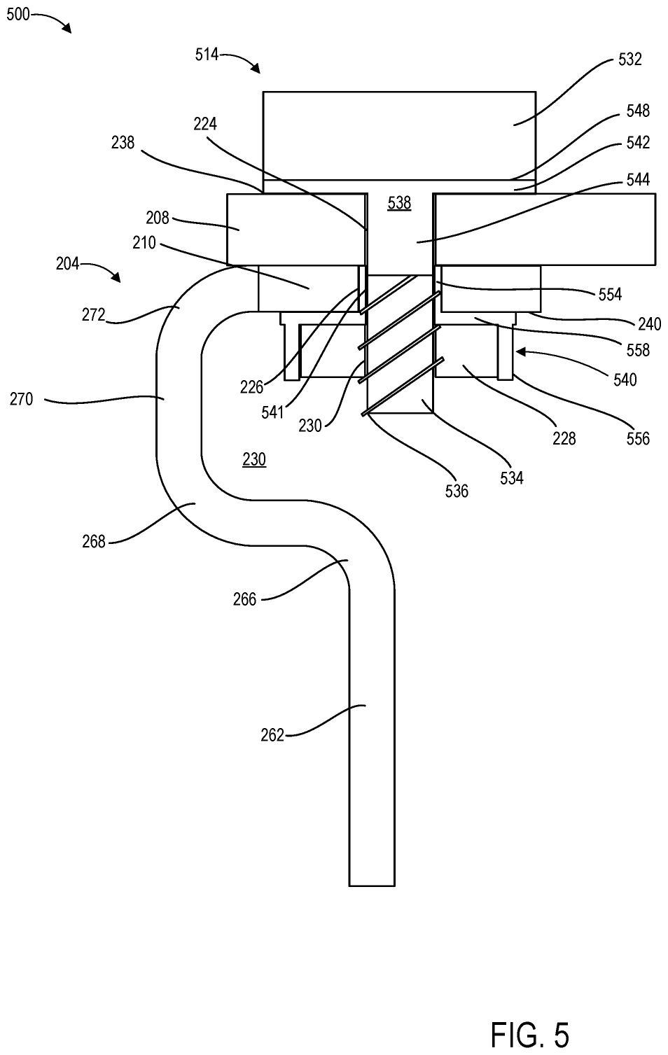

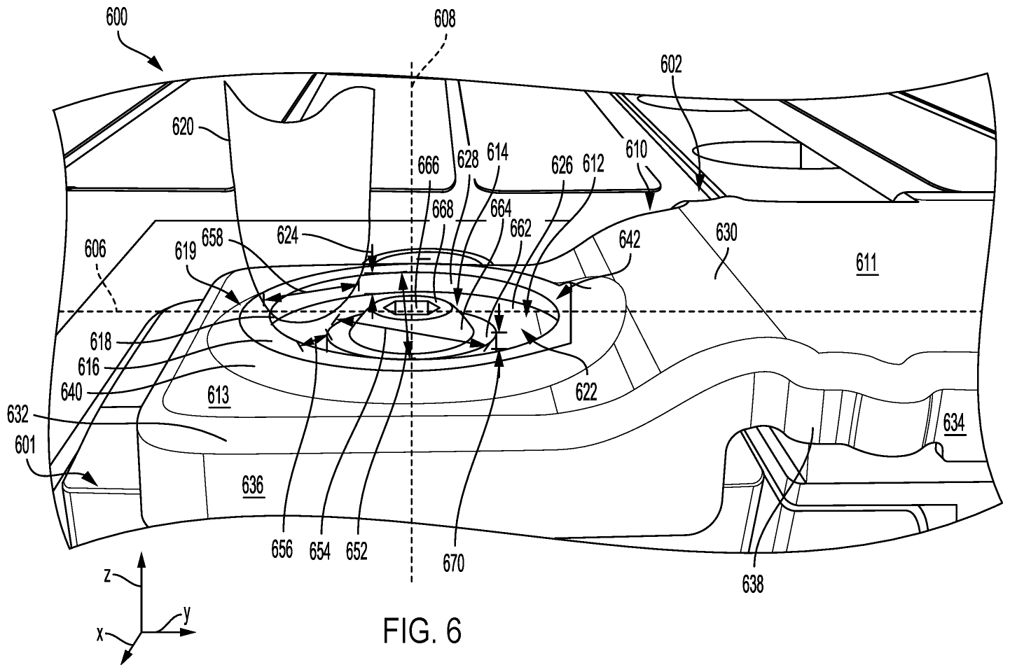

FIG. 1 shows an example schematic of a vehicle which may include the transmission of the present disclosure. The vehicle in FIG. 1 may be an electrified vehicle such as a EV or a hybrid vehicle with multiple sources of torque that may include an electric motor, a hydrogen fuel cell, and/or another mover that is not an internal combustion (ICE) engine. FIG. 2 shows an example schematic of a bus bar assembly with a bus bar electrically coupling a first array terminal and a second array terminal. The first and second array terminal may be part of a first battery array and a second battery array, respectively, for a battery pack. FIG. 3 shows the bus bar fastened to the first array terminal of FIG. 2 with a first configuration of fastener. The first configuration of fastener is comprised of dielectric material. FIG. 4 shows the bus bar fastened to the first array terminal of FIG. 2 with a second configuration of fastener. The second configuration of fastener has a coating comprised of dielectric material. FIG. 5 shows the bus bar fastened to the first array terminal of FIG. 2 with a third configuration of fastener. The third configuration of fastener has a component comprised of dielectric material about more conductive components of the fastener and sandwiched between portions of the fastener and the bus bar. FIG. 6 shows a first view of a bus bar assembly with a bus bar cover and a configuration of fasteners of the present disclosure.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

FIG. 6 is shown approximately to scale; though other relative dimensions may be used. As used herein, the terms “approximately” is construed to mean plus or minus five percent of the range unless otherwise specified.

Further, FIGS. 1-6 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal of a vehicle in which the system is positioned. A lateral axis may be normal to the longitudinal axis. Features described as lateral may be approximately parallel with the lateral axis and normal to the longitudinal axis.

Turning now to FIG. 1, a vehicle 100 is shown comprising a powertrain 101 and a drivetrain 103. The vehicle 100 may have a front end 132 and a rear end 134, located on opposite sides of vehicle 100. Objects, components, and features of the vehicle 100 referred to as being located near the front may be closest to the front end 132 compared to the rear end 134. Objects, components, and features of the vehicle 100 referred to as being located near the rear may be closest to the rear end 134 compared to the front end 132. The powertrain 101 comprises a prime mover 106 and a transmission 108. The prime mover 106 may be an internal combustion engine (ICE) or an electric motor, for example, and is operated to provide rotary power to the transmission 108. The transmission 108 may be any type of transmission, such as a manual transmission, an automatic transmission, or a continuously variable transmission. The transmission 108 receives the rotary power produced by the prime mover 106 as an input and outputs rotary power to the drivetrain 103 in accordance with a selected gear or setting. Additionally, there may be other movers in the vehicle besides prime mover 106. If the prime mover 106 is an ICE there may be at least a second mover with an input to the transmission 108, wherein the second mover may be an electric machine such as an electric motor. In one example, if there are a single or plurality of second movers in addition to the prime mover 106, the vehicle 100 may be a hybrid vehicle, wherein there are multiple torque inputs to the transmission 108. The vehicle 100 may have a longitudinal axis 130. The powertrain 101 and drivetrain 103 may have a length parallel with the longitudinal axis 130.

The prime mover 106 may be powered via energy from an energy storage device 105. In one example, the energy storage device 105 is a battery configured to store electrical energy. An inverter 107 may be arranged between the energy storage device 105 and the prime mover 106 and configured to adjust direct current (DC) to alternating current (AC). The inverter 107 may include a variety of components and circuitry with thermal demands that effect an efficiency of the inverter.

In some example embodiments, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged near a front of the vehicle 100 and thereby be a front axle, and the second axle assembly 112 is arranged near a rear of the vehicle 100 and thereby be a rear axle. The drivetrain 103 is shown in a four-wheel drive configuration, although other configurations are possible. For example, the drivetrain 103 may include a rear-wheel drive, a front wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In some configurations, such as shown in FIG. 1, the drivetrain 103 includes a transfer case 110 configured to receive rotary power output by the transmission 108. For an example, a first driveshaft 113 is drivingly coupled to a first output 111 of the transfer case 110, while a second driveshaft 122 is drivingly coupled to a second output 121 of the transfer case 110. The first driveshaft 113 (e.g., a front driveshaft) may transmit rotary power from the transfer case 110 to a first differential 116 of the first axle assembly 102 to drive the first set of wheels 104, while the second driveshaft 122 (e.g., a rear driveshaft) may transmits the rotary power from the transfer case 110 to a second differential 126 of the second axle assembly 112 to drive the second set of wheels 114. For an example, the first differential 116 may be drivingly coupled to a first set of axle shafts 118 coupled to the first set of wheels 104. For this or another example, the second differential 126 may be drivingly coupled to a second set of axle shafts 128 coupled to the second set of wheels 114. It may be appreciated that each of the first set of axle shafts 118 and the second set of axle shafts 128 may be positioned in a housing. The first driveshaft 113 and second driveshaft 122 may be positioned to extend in parallel with the longitudinal axis 130. For an example of a configuration of vehicle 100, the second driveshaft 122 may be centered about the longitudinal axis 130.

For an example, the first differential 116 may supply a forward wheel drive (FWD) in some capacity to vehicle 100, as part of rotary power transferred via the first driveshaft 113. Likewise, for this or another example, the second differential 126 may supply a rear wheel drive (RWD) to vehicle 100, as part of the rotary power transferred via the second driveshaft 122. The first differential 116 and the second differential 126 may supply a FWD and RWD, respectively, as part of an all-wheel drive (AWD) mode for vehicle 100.

The vehicle 100 may be a commercial vehicle, light, medium, or heavy duty vehicle, a passenger vehicle, an off-highway vehicle, and/or sport utility vehicle. Additionally or alternatively, the vehicle 100 and/or one or more of its components may be in industrial, locomotive, military, agricultural, and/or aerospace applications. In one example, the vehicle 100 is an all-electric vehicle or a vehicle with all-electric modes of operation, such as a plug-in hybrid vehicle. As such, the prime mover 106 is an electric machine. In one example, the prime mover 106 is an electric motor/generator.

In some examples, additionally or alternatively, the vehicle 100 may be a hybrid vehicle including both an engine an electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

Turning to FIG. 2, it shows a schematic 200 of an electrical joint assembly 202, such as of the vehicle battery. The electrical joint assembly 202 may comprise a first array and a second array, wherein each array is electrically coupled via an electrical joint. An electrical system may comprise the electrical joint assembly 202, such that other components of the electrical system may be electrically coupled to the electrical joint assembly 202. Other electrical components of the electrical system may be electrically coupled via the electrical joint assembly 202. Each array may also electrically couple different electrical components, such as a first electrical component and a second electrical component, via the electrical joint. The aforementioned electrical components are not contiguous or in surface sharing contact with one another, and may be electrically coupled via the electrical joint and arrays of the electrical joint assembly 202. For the example shown in schematic 200, the electrical system may comprise a battery assembly 203, such as a battery pack. The battery assembly 203 may comprise the electrical joint assembly 202 and a plurality of battery components 205. The battery assembly 203 and battery components 205 may comprise a battery or a plurality of batteries, such as the energy storage device 105 of FIG. 1. Components and features of the electrical joint assembly 202 may be enclosed by a plurality of dashed lines. The other battery components 205 may be separated from the electrical joint assembly by a dashed line 207. The first array and second array may be a part of the battery assembly 203 and may be physically and electrically coupled to the battery components 205. The first array may comprise a first array terminal 204, and the second array may comprise a second array terminal 206. The first array terminal 204 and second array terminal 206 may each be electrically coupled to the electrical joint. The electrical joint may be rated for a high voltage of electricity transfer between first array terminal 204 and the second array terminal 206, and therein may be a high voltage electrical joint. The electrical joint in schematic 200 is a bus bar 208. It is to be appreciated, that the use of a bus bar may be non-limiting, and that another high voltage electrical joint may be used.

The bus bar 208 may be fastened to the battery assembly 203 or another electrical assembly via a plurality of non-conductive fasteners. For example, the bus bar 208 may physically couple to the first array terminal 204 via fastening by a first non-conductive fastener 214. The bus bar 208 may be physically coupled to the second array terminal 206 via fastening by a second non-conductive fastener 216. The first array terminal 204 may comprise a first mounting region 210, and the second array terminal 206 may comprise a second mounting region 212. When fastened to the first array terminal 204, the bus bar 208 may rest upon, be supported by, and abut the first mounting region 210. When fastened to the second array terminal 206, the bus bar 208 may rest upon, be supported by, and abut the second mounting region 212. Portions of the first non-conductive fastener 214 may be passed through the bus bar 208 and the first mounting region 210 along a first axis 218, such as when fastening the bus bar 208 to the first mounting region 210. The first non-conductive fastener 214 may be approximately centered about the first axis 218, such as when fastening the bus bar 208 to the first mounting region 210. Portions of the second non-conductive fastener 216 may be passed through the bus bar 208 and the second mounting region 212 along a first axis 218, such as when fastening the bus bar 208 to the second mounting region 212. The second non-conductive fastener 216 may be approximately centered about the first axis 218, such as when fastening the bus bar 208 to the first mounting region 210. The first axis 218 may be a helical axis for the first non-conductive fastener 214, and the second axis 220 may be a helical axis for the second non-conductive fastener 216. The first and second non-conductive fasteners 214, 216 may be the same type of fasteners, wherein each fastener may have the same features and of approximately the same dimensions. When of the same type, the first and second non-conductive fasteners 214, 216 may be used interchangeably for mounting the bus bar 208 to the first and second mounting regions 210, 212, respectively.

The bus bar 208 may have a first hole 224 and the first mounting region 210 may have a second hole 226. The first hole 224 and second hole 226 may be aligned, such that each hole may be located about the first axis 218, and the first axis 218 may be approximately collinear with the centerlines of the first hole 224 and second hole 226. The first non-conductive fastener 214 may be complementary to the first hole 224 and the second hole 226, such that the first non-conductive fastener 214 may be passed and extend through the first hole 224 and second hole 226. Likewise, the first non-conductive fastener 214 may be complementary to a first washer 228, such that the first washer 228 may be positioned about portions of the first non-conductive fastener 214. Portions of the first non-conductive fastener 214 may be passed through a hole 230 of the first washer 228. For one example, the first washer 228 may comprise non-conductive material. For another example, the first washer 228 may have an outer layer coated with a non-conductive material, such as a dielectric material. The dielectric material comprising or coating the first washer 228 may insulate the first washer 228 from the transfer of electrical energy.

Each embodiment of the first non-conductive fastener 214 may comprise at least a head and a shank, such as a first head 232 and a first shank 234, respectively. The first shank 234 may have a first threading 236 comprised of a plurality of threads. The first threading 236 may be complementary to at least the surfaces of the hole 230. The first mounting region 210 may have a first inner surface 240. The first washer 228 may abut the first inner surface 240. The first head 232 of the first non-conductive fastener 214 may abut a mounting surface 238 of the bus bar 208. The first mounting surface 238 may be about the first hole 224.

The bus bar 208 may also have a third hole 244 and the second mounting region 212 may have a fourth hole 246. The third hole 244 and fourth hole 246 may be aligned, such that each hole may be located about the second axis 220, and the second axis 220 may be approximately collinear with the centerlines of the third hole 244 and fourth hole 246. The second non-conductive fastener 216 may be complementary to the third hole 244 and fourth hole 246, such that the second non-conductive fastener 216 may be passed and extend through the third hole 244 and fourth hole 246. Likewise, the second non-conductive fastener 216 may be complementary to a second washer 248, such that the second washer 248 may be positioned about portions of the second non-conductive fastener 216. Portions of the second non-conductive fastener 216 may be passed through a hole 250 of the second washer 248. The second washer 248 may comprise or have an outer layer coated with a non-conductive material, such as a dielectric material. The dielectric material comprising or coating the second washer 248 may insulate the second washer 248 from the transfer of electrical energy.

Each embodiment of the second non-conductive fastener 216 may comprise a head and a shank, such as a second head 252 and a second shank 254, respectively. The second shank 254 may have a second threading 256 comprised of a plurality of threads. The second threading 256 may be complementary to at least the surfaces of the hole 250. The second shank 254 may be passed through the third hole 244, fourth hole 246, and hole 250. The second shank 254 may be threaded through at least the hole 250. The second mounting region 212 may have a second inner surface 259. The second washer 248 may abut the second inner surface 259. The second head 252 of the second non-conductive fastener 216 may abut a mounting surface 258 of the bus bar 208. The mounting surface 258 may be about the third hole 244. It is to be appreciated, that the mounting surface 238 and the mounting surface 258 may be continuous with one another or part of the same surface.

The structure of the first array terminal 204 and second array terminal 206, with exception to the first mounting region 210 and second mounting region 212, may vary. For one example, the first array terminal 204 and second array terminal 206 may each comprise a plurality of walls continuous with one another via curves.

For an example, both the first array terminal 204 and second array terminal 206 may have components located about and forming a perimeter for a first cavity 260 and a second cavity 262. The first array terminal 204 may have a first wall 264 and a second wall 270. The first wall 264 may be a supporting wall for the first array terminal 204. The first wall 264 may physically couple to the battery components 205 and structurally support the first mounting region 210 and the bus bar 208. The first wall 264 may also electrically couple the first array terminal 204 to the battery components 205. The second wall 270 may be positioned between the first wall 264 and the first mounting region 210. The first wall 264 may be contiguous or continuous with the second wall 270 via a first curve 266 and a second curve 268. The second wall 270 may be connected and contiguous with the first mounting region 210 via a third curve 272. The first curve 266, second curve 268, second wall 270, third curve 272 and first mounting region 210, may be located about and form a perimeter about the first cavity 260. When the first non-conductive fastener 214 fastens the bus bar 208 to the first mounting region 210, a portion of the first shank 234 may extend into the first cavity 260.

The second array terminal 206 may have a third wall 274 and a fourth wall 280. The third wall 274 may be a supporting wall for the second array terminal 206. The third wall 274 may physically couple to the battery components 205. The third wall 274 may also electrically couple the first array terminal 204 to the battery components 205. The third wall 274 may structurally support the second mounting region 212 and the bus bar 208. The fourth wall 280 may be positioned between the third wall 274 and the first mounting region 210. The third wall 274 may be contiguous or continuous with fourth wall 280 via a fourth curve 276 and a fifth curve 278. The fourth wall 280 may be connected to and contiguous with the second mounting region 212 via a sixth curve 282. The fourth curve 276, fifth curve 278, fourth wall 280, sixth curve 282, and second mounting region 212, may be located about and form a perimeter of the second cavity 262. When the second non-conductive fastener 216 fastens the bus bar 208 to the second mounting region 212, a portion of the second shank 254 may extend into the second cavity 262.

As an example, the first non-conductive fastener 214 may be fastened to the first washer 228 through the first hole 224 and second hole 226. When fastened, the first hole 224 and second hole 226 may be located about and in surface sharing contact with portions of the first non-conductive fastener 214. The first washer 228 may be located and physically coupled about portions of the first non-conductive fastener 214. The first washer 228 may be in surface sharing contact with the first mounting region 210. The first non-conductive fastener 214 may be passed through a hole 230 of the first washer 228. For one example, the first non-conductive fastener 214 may be threaded through the hole 230. The first washer 228 may be located about portions of the non-conductive fastener 214 that extend below the second hole 226. The first washer 228 may comprise or be coated with a non-conducting material, such as a dielectric material. When comprised of or coated with a non-conducting material, the first washer 228 may not conduct or be insulated from receiving electrical energy when in surface sharing contact with an electrified component, such as the first mounting region 210.

The first shank 234 may extend in a direction normal to the mounting surface 238 of the bus bar 208, through the first hole 224 and second hole 226. The first threading 236 may be complementary to a threading or grooves of the hole 230 of the first washer 228. For an example, when the shank 234 extends through the first hole 224, second hole 226, and hole 230 and is threaded through at least the hole 230, the first non-conductive fastener 214 may fasten to the first washer 228. When fastened to the first washer 228 as described above, the first non-conductive fastener 214 may fasten the bus bar 208 to the first mounting region 210. The first threading 236 may also be complementary to a threading or groove on the surfaces of the first hole 224 and second hole 226. For another example, when the first shank 234 is threaded through the first hole 224, second hole 226, and hole 230, the first non-conductive fastener 214 may fasten to the bus bar 208, the first mounting region 210, and the first washer 228. When fastened to the first hole 224, second hole 226, and the first washer 228 as described above, the first non-conductive fastener 214 may fasten the bus bar 208 to the first mounting region 210.

The first head 232 may abut the first mounting surface 238 of the bus bar 208 when the first shank 234 is passed through the first hole 224. The first washer 228 may abut the first inner surface 240, such as when the first washer 228 is fastened to the shank 234 and the shank 234 extends through the first hole 224 and second hole 226. The first head 332 may apply a compressive force in a direction normal to the mounting surface 238. The first washer 228 may apply a compressive force normal to the first inner surface 240. The compressive force of the washer 228 and the first head 332 may have magnitudes in opposite directions of one another. The first head 232 may press the bus bar 208 against the first mounting region 210. The first washer 228 may press the first mounting region 210 against the bus bar 208. The compressive force from the first washer 228 and first head 232, may fasten the bus bar 208 to the first mounting region 210.

For this or another example, the second non-conductive fastener 216 may be fastened to the second washer 248 through the third hole 244 and fourth hole 246. The third hole 244 and fourth hole 246 may be located about and in surface sharing contact with portions of the non-conductive fastener 214. A second washer 248 may be located and physically coupled about portions of the second non-conductive fastener 216. The second washer 248 may be in surface sharing contact with the second mounting region 212. The second non-conductive fastener 216 may be passed through a hole 250 of the second washer 248. The first non-conductive fastener 214 may be threaded through the hole 250. The second washer 248 may be located about portions of the non-conductive fastener 214 that extend below the fourth hole 246. The second washer 248 may comprise or be coated with a layer of non-conducting material, such as a dielectric material. When comprised of or coated with a non-conducting material, the second washer 248 may not conduct or be insulated from receiving electrical energy when in surface sharing contact with an electrified component, such as the first mounting region 210.

The second shank 254 may extend in a direction normal to the mounting surface 258 of the bus bar 208, through the first hole 224 and second hole 226. The second threading 256 may be complementary to a threading or grooves of the hole 250 of the second washer 248. For an example, when the second shank 254 extends through the third hole 244, fourth hole 246, and hole 250 and is threaded through at least the hole 250, the first non-conductive fastener 214 may fasten to the second washer 248. When fastened to the second washer 248 as described above, the first non-conductive fastener may fasten the bus bar 208 to the second mounting region 212. The second threading 256 may also be complementary to a threading or groove on the surfaces of the third hole 244 and fourth hole 246. For another example, the second shank 254 may be threaded through and fastened to the third hole 244, fourth hole 246, and hole 250. The second non-conductive fastener 216 may fasten to the bus bar 208, the second mounting region 212, and the second washer 248. When fastened to the third hole 244, fourth hole 246, and hole 250 as described above, the second non-conductive fastener 216 may fasten the bus bar 208 to the second mounting region 212.

The second head 252 may abut the second mounting surface 258 of the bus bar 208 when the second shank 254 is passed through the first hole 224. The second washer 248 may abut the second inner surface 259 when the second washer 248 is fastened to the second shank 254 and the second shank 254 extends through the third hole 244 and fourth hole 246. The second washer 248 and second head 252 may apply compressive force in opposite directions normal to the second mounting surface 258 and the second inner surface 259, respectively. The compressive force from the second washer 248 and the second head 252 may fasten the bus bar 208 to the second mounting region 212. The second head 252 may press the bus bar 208 against the second mounting region 212. The second washer 248 may press the second mounting region 212 against the bus bar 208.

Turning to FIG. 3, it shows a first schematic of a first configuration 300 for fastening the bus bar 208 to the first mounting region 210 of the first array terminal 204. The first configuration 300 shows the bus bar 208 may be fastened to the first mounting region 210 via a first fastener 314. For an example, the bus bar may be fastened to the first mounting region 210 with at least one non-conductive fastener, such as the first fastener 314. The first fastener 314 may be a first configuration fastener of the first non-conductive fastener 214 of FIG. 2. Likewise, the first fastener 314 may be a first configuration of the second non-conductive fastener 216 of FIG. 2. For the example shown in in the first configuration 300, the first fastener 314 may be used as the first non-conductive fastener 214. The first fastener 314 may fasten the bus bar 208 to the first mounting region 210, and by extension the first bus bar 208 to the first array terminal 204.

For an example, at least one non-conductive fastener that fastens the bus bar 208 may be comprised of a dielectric material. The first fastener 314 is of a configuration that comprises a dielectric material, such as a polymer, that may electrically insulate the first fastener 314 from the bus bar 208. As an example, the first fastener 314 may comprise a Nylon, such as PA6 or PA66, as a dielectric and insulating material. As another example, the first fastener 314 may comprise a silicone as a dielectric and insulating material. For one example, the first fastener 314 may be a cap screw, such as a PEEK screw (e.g., SPE-M6-10-C). The dielectric material comprising the first fastener 314 is a heat resistant and stable material to prevent degradation during operation. The stability of the material refers to mechanical stability (e.g., mechanical strength), such as tensile strength, compressive strength, and hardness, such that the dielectric material may resist mechanical degradation from stress, strain, and other forces exerted during assembly or operation in a complementary vehicle, such as vehicle 100 of FIG. 1. Stability also refers to chemical stability, such as resistance to corrosion or other forms of chemical degradation. For example, the dielectric material of the fastener 314 may resist degradation from chemical reactions caused by electrical energy or from compounds that may be reactive, such as lithium or acids, housed within a battery of a battery assembly, such as battery assembly 203 of FIG. 2. The insulation of the dielectric material may prevent or reduce the quantity of electrical energy from discharging between the bus bar and the first fastener 314. Likewise, the first fastener 314 may not transfer current or may resist transferring current from the bus bar 208 to an object in surface sharing contact with the first fastener 314.

The first fastener 314 may comprise a head 332, shank 334, and a threading 336. For the first fastener 314, the material of the head 332, shank 334, and threading 336 comprises a dielectric material. The head 332, shank 334, and threading 336 may be the first head 232, the first shank 234, and first threading 236, respectively, of the first non-conductive fastener 214. Likewise, the head 332, shank 334, and threading 336 may be the second head 252, the second shank 254, and second threading 256, respectively, of the second non-conductive fastener 216.

For this example, head 332 may abut the first mounting surface 238. The shank 334 may extend in a direction normal to the mounting surface 238, through the first hole 224 and second hole 226. The washer 228 may be positioned about the shank 334. When positioned about the shank 334, the shank 334 may extend through the hole 230 of the washer 228. The washer 228 may abut the first inner surface 240. The washer 228 and head 332 may apply compressive force in the opposite directions normal to the first mounting surface 238 and first inner surface 240, respectively. The compressive force from the washer 228 and head 332 and the structure of the fastener 314 as a whole, may fasten the bus bar 208 to the first mounting region 210. The hole 230 may be complementary to the shank 334 and threading 336, such that the threading 336 may mesh with a complementary threading or grooves of the hole 230. The head 332 may press the bus bar 208 against the first mounting region 210. The washer 228 may press the first mounting region 210 against the bus bar 208. Likewise, if complementary to the surfaces of the first hole 224 and the second hole 226, the threading of the threading 336 with the first hole 224 and the second hole 226 may fasten the bus bar 208 to the first mounting region 210.

Turning to FIG. 4, it shows a third schematic of a second configuration 400 for fastening the bus bar 208 to the first mounting region 210 of the first array terminal 204. The second configuration 400 shows the bus bar 208 may be fastened to the first mounting region 210 via a second fastener 414. For an example, the bus bar may be fastened to the first mounting region 210 with at least one non-conductive fastener, such as the second fastener 414. The second fastener 414 may be a second configuration of fastener for the first non-conductive fastener 214 of FIG. 2. Likewise, the second fastener 414 may be a second configuration of fastener for the second non-conductive fastener 216 of FIG. 2. For the example shown in in the second configuration 400, the second fastener 414 may be used as the first non-conductive fastener 214. The second fastener 414 may fasten the bus bar 208 to the first mounting region 210, and by extension the first bus bar 208 to the first array terminal 204.

The second fastener 414 may comprise a second head 432, second shank 434, and a second threading 436. The material of the core of the second fastener 414, such as the material comprising of the head 432, shank 434, and threading 436, may comprise metal or a metal alloy, such as aluminum or an aluminum alloy, respectively. The material of the core of the second fastener 414, such as the material of the head 432, shank 434, and threading 436, may also be another material that may be conductive to electricity. The second head 432, second shank 434, and second threading 436 may be the first head 232, the first shank 234, and first threading 236, respectively, of the first non-conductive fastener 214. Likewise, the second head 432, second shank 434, and second threading 436 may be the second head 252, the second shank 254, and second threading 256, respectively, of the second non-conductive fastener 216. For an example, at least one non-conductive fastener may be coated with a layer of dielectric material, such as the second fastener 414, and used to fasten an electrical joint, such as bus bar 208, to an assembly. The surfaces of the second fastener 414 may be encased in layer of a coating 440. The coating 440 may encase and comprise the outer surfaces of the head 432, the shank 434, and the threading 436.

For this example, the coating 440 about the head 432 may abut the first mounting surface 238. The shank 434 may extend in a direction normal to the mounting surface 238, through the first hole 224 and second hole 226. The coating about the shank 434 and threading 436 may be in surface sharing contact with the first hole 224 and second hole 226. The washer 228 may be positioned about the shank 434. When the washer 228 is positioned about the shank 434, a section of the shank 434 and the coating 440 about the shank 434 may extend through the hole 230 of the washer 228. The washer 228 may abut the first inner surface 240. The washer 228 and head 432 may apply compressive force in the opposite directions normal to the first mounting surface 238 and first inner surface 240, respectively. The compressive force from the washer 228 and head 432 may fasten the bus bar 208 to the first mounting region 210. The hole 230 may be complementary to the shank 434, threading 436, and coating 440 about the threading 436. The threading 436 and coating 440 about the threading 436 may mesh with a complementary threading or grooves of the hole 230. The head 432 may press the bus bar 208 against the first mounting region 210. The washer 228 may press the first mounting region 210 against the bus bar 208. Likewise, if complementary to the surfaces of the first hole 224 and the second hole 226, the threading of the threading 436 and coating 440 about the threading 436 with the first hole 224 and the second hole 226 may fasten the bus bar 208 to the first mounting region 210.

The coating 440 may comprise a dielectric material, such as a polymer or an anodized material, that may electrically insulate the second fastener 414 from the bus bar 208. As an example, the coating 440 may comprise a Nylon, such as PA6 or PA66, as a dielectric and insulating material. As another example, the coating 440 may comprise a silicone as a dielectric and insulating material. The dielectric material comprising coating 440 is a heat resistant and stable material. The stability of the material comprising the coating 440 refers to mechanical stability (e.g., mechanical strength), such as tensile strength, compressive strength, and hardness, such that the dielectric material may resist mechanical degradation from stress, strain, and other forces exerted during assembly or operation in a complementary vehicle, such as vehicle 100 of FIG. 1. Stability of the material comprising the coating 440 also refers to chemical stability, such as resistance to corrosion or other forms of chemical degradation. For example, the dielectric material comprising the coating 440 may resist degradation from chemical reactions caused by electrical energy or from compounds that may be reactive, such as lithium or acids, housed within a battery of a battery assembly, such as battery assembly 203 of FIG. 2. The insulation of the dielectric material of the coating 440 may prevent or reduce the quantity of electrical energy from discharging between the bus bar 208 and the second fastener 414. Likewise, the second fastener 414 may not transfer current or may resist transferring current from the bus bar 208 to an object in surface sharing contact with the second fastener 414.

Turning to FIG. 5, it shows a fourth schematic of a third configuration 500 for fastening the bus bar 208 to the first mounting region 210 of the first array terminal 204. The third configuration 500 shows the bus bar 208 may be fastened to the first mounting region 210 via a third fastener 514. For an example, the bus bar may be fastened to the first mounting region 210 with at least one non-conductive fastener, such as the third fastener 514. The third fastener 514 may be a third configuration of a fastener of the first non-conductive fastener 214 of FIG. 2. Likewise, the third fastener 514 may be a third configuration of fastener of the second non-conductive fastener 216 of FIG. 2. For the example shown in in the third configuration 500, the third fastener 514 may be used as the first non-conductive fastener 214. The third fastener 514 may fasten the bus bar 208 to the first mounting region 210, and by extension the first bus bar 208 to the first array terminal 204.

The third fastener 514 may comprise a third head 532, third shank 534, and a third threading 536. For the third fastener 514, the material of the head 532, shank 534, and threading 536 may comprise a metal or a metal alloy, such as aluminum or an aluminum alloy, respectively. The core material of components of the fastener 514, such as the material of the head 532, shank 534, and threading 536, may also be another material that may be conductive to electricity. The third head 532, third shank 534, and third threading 536 may be the first head 232, the first shank 234, and first threading 236, respectively, of the first non-conductive fastener 214. Likewise, the third head 532, third shank 534, and third threading 536 may be the second head 252, the second shank 254, and second threading 256, respectively, of the second non-conductive fastener 216.

For an example, at least one non-conductive fastener has components comprised of non-conductive material, such as the third fastener 514. The components comprised of non-conductive material may prevent surface sharing contact between a plurality of features of the non-conductive fastener not comprised of dielectric material and the bus bar 208.

The third fastener 514 may also comprise an overmold 538 and an insert 540. A portion of the overmold 538 may be located about portions of head 532. Likewise, a portion of the overmold 538 may be located about portions of the shank 534. Portions of the overmold 538 may be sandwiched between the head 532 and the first mounting surface 238. Likewise, the insert 540 may be located about portions of the shank 534. The insert 540 may be complementary to the threading 536, such that the shank 534 may be threaded through a hole 541 of the insert 540. Portions of the insert 540 may be sandwiched between the first inner surface 240 and the washer 228. Likewise, portions of the insert 540 may be located about the washer 228, such as radially about the washer 228 with respect to a centerline of the washer 228. The third fastener 514 may be prevented from making surface sharing contact with bus bar 208 via the overmold 538 and insert 540. The overmold 538 may prevent surface sharing contact between the head 532 and portions of the shank 534 and the bus bar 208. For example, the overmold 538 may be positioned about portions of the head 532 and shank 534, the head 532. The overmold 538 may prevent the head 532 from surface sharing contact with the first mounting surface 238, such as when the third fastener 514 fastens the bus bar 208 to the first mounting region 210. Likewise, the overmold 538 may prevent the shank 534 from surface sharing contact with the first hole 224, such as when the third fastener 514 fastens the bus bar 208 to the first mounting region 210. The overmold 538 may prevent the shank 534 from surface sharing contact with the second hole 226, such as when the third fastener 514 fastens the bus bar 208 to the first mounting region 210.

The overmold 538 may comprise a first portion and a second portion as a head section 542 and a shank section 544, respectively. The head section 542 may be located about portions of the shank 534 and be sandwiched between the head 532 and the first mounting surface 238. Portions of the head 532 may abut a first platform 548. The first platform 548 may act as a spacer, preventing surface sharing contact between the third head 532 and the mounting surface 238. The first platform 548 may also be a first spot face and may have portions located about the head 532, such as a rim or a collar. The shank section 544 may be positioned below the head section 542, such as when shank is inserted through the first and second hole 224, 226. The shank section 544 may prevent surface sharing contact between the shank 534 and the surfaces of the bus bar 208 about the first hole 224. When the overmold 538 is about and physically coupled to the other components of the third fastener 514 and the third fastener 514 is fastens the bus bar 208 to the first mounting region 210, shank 534 may not be in surface sharing contact with the surfaces of the bus bar 208 about the first hole 224. For one example, the shank section 544 may be located about portions of the shank 534. The shank section 544 may be located radially about portions of the shank 534, with respect to the centerline of the third fastener 514. For another example, the shank section 544 may be sandwiched between the shank 534 to the head section 542. For this example, the head section 542 and shank section 544 may physically couple the shank 534 to the head 532.

The insert 540 may comprise a first collar 554 and a second collar 556. The first collar 554 may be positioned about the shank 534. The first collar 554 may be contiguous with the second collar 556 via a second platform 558. The first collar 554 may be positioned radially about portions of the shank 534 with respect to centerline of the shank 534. The first collar 554 may have surface sharing contact with the shank 534. The first collar 554 may prevent surface sharing contact between the shank 534 the surfaces of the first mounting region 210 about the second hole 226. When inserted into the first collar 554, the shank 534 may not be in surface sharing contact with the surfaces of the first mounting region 210 about the second hole 226. The second collar 556 may be positioned about the washer 228 and the shank 534, wherein the washer 228 is positioned radially between the second collar 556 and a portion of the shank 534, with respect to a centerline of the shank 534. The second platform 558 may be a spot face for the insert 540. The second platform 558 may be positioned to be in surface sharing contact with the first inner surface 240. The first washer 228 may be positioned to be in surface sharing contact with the second platform 558. The second platform 558 may be sandwiched between the first washer 228 and the inner surface 240, such that the first washer 228 may not be in surface sharing contact with the first mounting region 210.

The overmold 538 and the insert 540 may be comprised of a dielectric material, such as a polymer. As an example, the overmold 538 and the insert 540 may comprise a Nylon, such as PA6 or PA66, as a dielectric and insulating material. As another example, the overmold 538 and the insert 540 may comprise a silicone as a dielectric and insulating material. Both the overmold 538 and the insert 540 may prevent surface sharing contact between metal or metal alloy comprised components of the third fastener 514, such as the head 532 and shank 534, and electrically charged components, such as the bus bar 208 and the first array terminal 204.

The dielectric material comprising the overmold 538 and insert 540 is a heat resistant and stable material. The stability of the material comprising the overmold 538 and insert 540 refers to mechanical stability (e.g., mechanical strength), such as tensile strength, compressive strength, and hardness, such that the dielectric material may resist mechanical degradation from stress, strain, and other forces exerted during assembly or operation in a complementary vehicle, such as vehicle 100 of FIG. 1. Stability of the material comprising the overmold 538 and insert 540 may also refer to chemical stability, such as resistance to corrosion or other forms of chemical degradation, such that the dielectric material may resist degradation from chemical reactions caused by electrical energy or from compounds that may be reactive, such as lithium or acids, housed within a battery of a battery assembly, such as battery assembly 203 of FIG. 2. The insulation of the dielectric material of the overmold 538 and insert 540 may prevent or reduce the quantity of electrical energy from discharging between the bus bar 208 and the third fastener 514. Likewise, the third fastener 514 may not transfer current or may resist transferring current from the bus bar 208 to an object in surface sharing contact with the third fastener 514. The third fastener 514 may also prevent or resist the transfer of current from a mounting region, such as the first mounting region 210, to a washer, such as the first washer 228, if the washer is comprised of a conductive material. For example, the first washer 228 may be positioned about the shank 534, such that the second collar 556 is positioned about the first washer 228 and the second platform 558 is sandwiched between the first washer 228 and the first mounting region 210. The second collar 556 and second platform 558 may prevent or reduce the transfer of electrical energy between the first washer 228 and the first inner surface 240.

A set of reference axes 601 are provided for comparison between views shown in FIG. 6. The reference axes 601 indicate a y-axis, an x-axis, and a z-axis. In one example, the z-axis may be parallel with a direction of gravity and the x-y plane may be parallel with a horizontal plane that a bus bar assembly 602 and components physically coupled to the bus bar assembly 602 may rest upon. For this example, the z-axis may be a vertical axis, wherein the z-axis may be parallel with a vertical direction. For this example, the y-axis may be a longitudinal axis and the x-axis may be a lateral axis, wherein the y-axis may be parallel with a longitudinal direction and the x-axis may be parallel with a lateral direction relative to the bus bar assembly 602. When referencing direction, positive may refer to in the direction of the arrow of the y-axis, x-axis, and z-axis and negative may refer to in the opposite direction of the arrow of the y-axis, x-axis, and z-axis. A filled circle may represent an arrow and axis facing toward, or positive to, a view. An unfilled circle may represent an arrow and an axis facing away, or negative to, a view.

Turning to FIG. 6, it shows a first view 600 of the bus bar assembly 602. The first view 600 may be a side view showing no favoritism toward any of the axes in the reference axes 601. The bus bar assembly 602 may be positioned about a longitudinal axis 606. Portions of the bus bar assembly 602 may also be positioned about a central axis 608. The bus bar assembly 602 may comprise a bus bar 612 and a bus bar cover 610.

The bus bar assembly 602 may be the electrical joint assembly 202 of FIG. 2. The bus bar assembly 602 may be clamped to an electrical system such as the battery components 205 of a battery assembly 203 of FIG. 2, wherein the bus bar assembly 602 may be the electrical joint assembly 202 of FIG. 2. The bus bar assembly 602 may be fastened to a first array terminal and a second array terminal, such as the array terminal 204 and second array terminal 206 of FIG. 2. For an example, the bus bar 612 may be fastened to at least a battery array, via a non-conductive fastener. A fastener 614 may fasten the bus bar 612 to an array terminal. When fastened to the bus bar 612, the fastener 614 may be centered about the central axis 608. The central axis 608 may be a helical axis for the fastener 614. As an example, the fastener 614 and central axis 608 may be the first non-conductive fastener 214 and first axis 218 of FIG. 2, respectively. As another example, the fastener 614 may be the second non-conductive fastener 216 and the second axis 220 of FIG. 2, respectively.

The bus bar cover 610 may have a first outer surface 611 and a second outer surface 613. The first and second outer surfaces 611, 613 may be top surfaces. The first outer surface 611 may be positioned above the second outer surface 613. The portions of the bus bar below the first outer surface 611 and second outer surfaces 613 may be in surface sharing contact with the bus bar 612. The first and second outer surfaces 611, 613 may be fit to the shape of the bus bar 612.

The bus bar 612 and the fastener 614 may be visible via an opening 618. A flange 616 may be located about and form the perimeter of the opening 618. The opening 618 may be a hole located above and about the centerline of the fastener 614. The opening 618 may also be a cutout. As an example, the opening 618 may be circular in shape. The opening 618 and flange 616 may be positioned approximately radially about the fastener 614, such that the opening 618 and flange 616 are radial with respect to the central axis 608. The opening 618 may be positioned radially about the fastener 614. A fastener interface region 619 may comprise the opening 618 and the flange 616. The fastener interface region 619 may comprise components that are contiguous between the flange 616 and the second outer surface 613. The fastener interface region 619 may be raised above the second outer surface 613.

An object 620 may be positioned above the opening 618 and the bus bar cover 610. The object 620 may be cylindrical in shape or have an approximately cylindrical section. The object 620 may be part of, joined to, or physically coupled to another larger object or part of a system of objects. The object 620 and objects physical coupled with the object 620 may conduct electricity. The object 620 and other objects physically coupled with the object 620 may have a threshold of current or a threshold of voltage. When discharged into the object 620, electrical energy that is above the threshold of current or the threshold of voltage may cause degradation to the object 620 and/or other objects physically coupled to the object 620. The threshold of current and threshold of voltage may be lower than the current and voltage carried by the bus bar 612. The object 620 may be used in clamping or other operations that may result in surface sharing contact between the object 620 and the bus bar assembly 602. When engaged in the aforementioned operations, the object 620 may be positioned to come in surface sharing contact with the fastener interface region 619. Likewise, object 620 may pass through the opening 618.

The opening 618 may extend upward from a first surface 622 of the bus bar 612 by approximately a distance 624. Likewise, the flange 616 may be raised from the bus bar 612, such that the flange 616 may be separated from a first inner surface 626 of the bus bar cover 610 by the distance 624. The flange 616 may prevent an object 620 from touching the surface 622. The flange 616 and opening 618 may allow object 620 to touch the fastener 614. The bus bar cover 610 may also have a second inner surface 628. The second inner surface 628 curves from the first inner surface 626 to the flange 616.

The first outer surface 611 may be contiguous with the second outer surface 613 and connected via a slope 630. The bus bar cover 610 may also have a plurality of outer surfaces, such as a first side surface 634 and a second side surface 636. The first and second side surfaces 634, 636 may be contiguous and connected to the first outer surface 611 and second outer surface 613. For example, the first outer surface 611 and slope 630 may be connected to and contiguous with the first side surface 634 via a plurality of first rounds 632. Likewise, second outer surface 613 and slope 630 may be connected to and contiguous with the second side surface 636 via the first rounds 632. The first side surface 634 and second side surface 636 may be connected to and contiguous with each other via a plurality of second rounds 638. The first outer surface 611 and slope 630 may be connected to and contiguous with the second rounds 638 via some of the first rounds 632.

Returning to the opening 618, the flange 616 may be continuous with the second outer surface 613. The flange 616 may be connected and continuous with the second outer surface 613 via a fillet 640. The fillet 640 may also join portions of the flange to the slope 630. Between the slope and the 630 and the opening 618, the flange 616 may have an edge 642. The edge 642 may approximately straight and not be rounded.

The object 620 may make surface sharing contact with a fastener, such as the fastener 614, but not the electrical joint, such as bus bar 612. The opening 618 may be of a first diameter 652. The fastener 614 may be of a second diameter 654. The difference between the first diameter 652 and second diameter 654 may be of a difference 656. The difference 656 is a distance that is less than a thickness 658 of the object 620. Flange 616 and opening 618 may therein prevent the object 620 from making surface sharing contact with the surface 622 or other features of the bus bar 612.

The first diameter 652, second diameter 654, and non-conductivity of the fastener 614 may prevent an object, such as object 620 or an object of a width or radius than thickness 658, from coming into surface sharing contact with or experiencing electrical discharge from the bus bar 612 and bus bar assembly 602. The first diameter 652, second diameter 654, and non-conductivity of the fastener 614 may provide interference to an object, such as an object smaller than object 620, from coming into surface sharing contact with or experiencing electrical discharge from the bus bar 612. Distance 624 may be a distance less than the heights between a bus bar and the material of a fastener interface region of bus bar covers from prior art. The distance 624 may be the height of the fastener interface region 619 and may be reduced compared fastener interface regions to prior art. The reduction in height of the fastener interface region 619 may reduce the height of the bus bar cover 610 and of the bus bar assembly 602. Reduction in height of the bus bar cover 610 and bus bar assembly 602 may reduce the height of and packing space taken up by an electrical system the bus bar assembly 602 may be electrically coupled to. Additionally, the first diameter 652 may allow for manipulation of the fastener 614 via an object, e.g. object 620, or a plurality of objects through the opening 618. Likewise, the first diameter 652, second diameter 654, and non-conductivity of the fastener 614 may provide interference for objects from making surface sharing contact with the bus bar cover 610 and bus bar assembly 602 while not using caps, or another forms of covers that are removable and positioned to enclose the opening 618.

The fastener 614 may be comprised of a land 662. The land 662 may abut the surface 622. The fastener 614 may also comprise a spot face 668 about an opening 666. The opening 666 may be receiver for a key or another tool to tighten, loosen, or manipulate the fastener 614. For one example the opening 666 may be hexagonal in shape and may be used for a hexagonally shaped key, such as an Allen key (e.g., an Allen wrench) or a hexagonal screw driver head. For another example the opening 666 may be complementary to the head of a screw driver or another tool, such as a Philips head, a flat head, torx head, square head, or a one-way head. The spot face 668 may be positioned above the land 662. The spot face 668 may be contiguous and joined with the land via a rise 664. For one example, the rise 664 forms a conical surface about the spot face 668 and within the perimeter of the land 662. The land 662 may be a height 670 from the surface 622. The height 670 may be a distance greater than a threshold of distance. At or below the threshold of distance, electrical discharge may occur between an object above a threshold of conductivity and the surface of the bus bar 612. The land 662 may therein prevent discharge of electricity between the object 620 and the bus bar 612.

In this way, an electrical joint cover, such as a bus bar cover, may be a reduced height when positioned and clamped onto an electrical joint. The reduced height of the electrical joint cover may reduce the height or z-space of an electrical assembly, such as a battery pack or another battery assembly, that the electrical joint assembly may be a part of. The reduced height of the electrical joint cover may reduce the height or z-space of an electrical system that comprises the electrical assembly. The electrical joint may be electrically coupled to a first array and a second array, and may electrically couple the first array to the second array such that high voltage electricity may flow from one array to the opposite array. Lowering the z-space may lower the top of a vehicle the electrical system is housed in. Lowering the z-space may also decrease the volume of the electrical system as a whole, allowing for the electrical assembly to have increased energy density.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of prime movers, internal combustion engines, and/or transmissions. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery pack, comprising:
a first battery array;
a second battery array; and
an electrical joint assembly having an electrical joint and a plurality of non-conductive fasteners,
the second battery array coupled to the first battery array via the electrical joint assembly with the plurality of non-conductive fasteners.

2. The battery pack of claim 1, where the electrical joint of the electrical joint assembly is a bus bar assembly and the electrical joint is a bus bar.

3. The battery pack of claim 1, where the plurality of non-conductive fasteners comprises a first non-conductive fastener and a second non-conductive fastener, where the first non-conductive fastener fastens the electrical joint to the first battery array and the second non-conductive fastener fastens the electrical joint to the second battery array.

4. The battery pack of claim 3, where the first non-conductive fastener physically couples to a first washer and the second non-conductive fastener physically couples to a second washer, where the first non-conductive fastener and first washer fasten the electrical joint to the first battery array and the second non-conductive fastener and second washer fasten the electrical joint to the second battery array.

5. The battery pack of claim 4, where the first washer and the second washer are non-conductive and comprise a dielectric material.

6. The battery pack of claim 4, where the first washer and the second washer are non-conductive and are coated with a layer comprising dielectric material.

7. The battery pack of claim 1, where at least one non-conductive fastener of the non-conductive fasteners is comprised of a dielectric material.

8. The battery pack of claim 1, where at least one non-conductive fastener of the non-conductive fasteners is coated with a layer of dielectric material.

9. The battery pack of claim 1, where at least one non-conductive fastener of the non-conductive fasteners has components comprised of dielectric material, that when fastening the electrical joint to the first battery array or second battery array.

10. The battery pack of claim 9, where the components comprised of dielectric material include an overmold and insert, where the overmold is positioned about and physically coupled to a shank of the non-conductive fastener, wherein a first portion of the overmold is sandwiched between a head of the non-conductive fastener, and a second portion of the overmold is positioned between the shank and the electrical joint.

11. The battery pack of claim 10, where the insert has a first collar and a second collar, wherein the first collar may be located about a washer.

12. The battery pack of claim 1, where the electrical joint of the electrical joint assembly has a cover comprised of a non-conductive material.

13. The battery pack of claim 12, where the cover has an opening, wherein the opening is positioned about a central axis of a non-conductive fastener, and the non-conductive fastener is configured to be set into the electrical joint via the opening.

14. The battery pack of claim 13, where the opening is a cutout of the cover.

15. A battery pack, comprising:
a bus bar assembly;
a first battery array; and a
second battery array, wherein the bus bar assembly includes a bus bar, and a bus bar cover, and wherein, the bus bar electrically coupled the first battery array to the second battery array, and the bus bar is physically coupled to one of the battery arrays via a non-conductive fastener, and the non-conductive fastener is configured to be set into the bus bar via an opening of the bus bar cover.

16. The battery pack of claim 15, where the opening is of a first diameter and the non-conductive fastener is of a second smaller diameter.

17. A method of forming a vehicle battery pack, including:
immovably fixedly coupling a first battery array to second battery array via a bus bar via a plurality of non-conductive fasteners by placing the fasteners through openings in a cover of the vehicle battery pack.

18. The method of claim 17, wherein the plurality of non-conductive fasteners comprises a first non-conductive fastener and a second non-conductive fastener, where the first non-conductive fastener fastens bus bar to the first battery array and the second non-conductive fastener fastens bus bar to the second battery array.

19. The method of claim 17, wherein the plurality of non-conductive fasteners comprise a dielectric material.

20. The method of claim 17, wherein the plurality of non-conductive fasteners are coated with a dielectric material.
